(19) United States
(12) Patent Application Publication
(10) Pub. No.: US 2008/0080049 A1
(43) Pub. Date: Apr. 3, 2008

(54) DISPLAY DEVICE, IMAGE PROCESSING METHOD, AND ELECTRONIC APPARATUS

(75) Inventors: Goro HAMAGISHI, Toyonaka City (JP); Nobuo SUGIYAMA, Suwa-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/864,592

(22) Filed: Sep. 28, 2007

(30) Foreign Application Priority Data
Sep. 29, 2006 (JP) 2006-268985
Jan. 11, 2007 (JP) 2007-003236

(51) Int. Cl. G02B 27/22

(52) U.S. Cl. 359/466; 348/51; 348/E13.031

(57) ABSTRACT

A display device for displaying a plurality of images in a display unit, the plurality of images including pixels including subpixels of different colors; a display unit capable of arranging the pixels in horizontal and vertical directions; an image data combining circuit capable of combining image data for the plurality of images; and an image separation member that spatially separates the plurality of images displayed on the display unit from each other, wherein the plurality of images are displayed as rows of display pixels, wherein the alternating subpixels of the images are displayed in the horizontal and vertical direction.

### BACKGROUND

The entire disclosure of Japanese Patent Application No. 2006-268985, filed Sep. 29, 2006 and Japanese Patent Application No. 2007-003236, filed Jan. 11, 2007 are expressly incorporated herein by reference.

1. Technical Field

The present invention relates to stereoscopic images. More specifically, the present invention relates to a display device, image processing method, and electronic apparatus capable of displaying a stereoscopic or a multi-viewpoint image which can be observed without using special glasses.

2. Related Art

Two methods for displaying a stereoscopic image without requiring special glasses, the parallax barrier method and the lenticular method, are known in the present art. According to the “stripe barrier method,” an image for the left eye (left-eye image) and an image for the right eye (right-eye image) are displayed on a screen using alternating columns of the images, which are arranged in a vertical stripes. The displayed images are separated using a parallax barrier or a lenticular lens. Using the parallax effect between the left and right eyes, the images are then displayed to the left and right eyes of an observer, creating a stereoscopic image.

FIG. 8 shows the schematic construction of a display device using the parallax barrier. On the screen W, columns of the left-eye image L and the right-eye image R are alternately displayed . Between the screen W and the observer H, an image separation member, such as a parallax barrier B is disposed for separating the left-eye image L and the right-eye image R from each other. The parallax barrier B is a light blocking film having a plurality of apertures which correspond to the left-eye image L and the right-eye image R. The parallax barrier B is capable of preventing the left-eye image L from being displayed to the right eye of the observer H and preventing the right-eye image R from being displayed to the left eye of the observer H. The parallax barrier B is provided with slits S, which are arranged into vertical stripes. By using the slits S, the left-eye image L can be shown to the left eye of the observer H, and the right-eye image R can be shown to the right eye of the observer H.

FIGS. 9A to 9C are explanatory diagrams showing a method for combining the left-eye image L and the right-eye image R onto one screen W. FIG. 9A shows image data DL′ for the left eye (left-eye image data) and image data DR′ for the right eye (right-eye image data) which are supplied to the display device. FIG. 9B shows left-eye image data DL and right-eye image data DR, which are obtained by compressing the left- and right-eye image data DL′ and DR′ in the horizontal direction, and FIG. 9C shows combined image data D obtained by rearranging the image data DR and DL into alternating columns and combining the rearranged image data.

As shown in FIGS. 9A to 9C, the horizontal resolution of each of the images L and R is ½ of the original resolution of the images. The left-eye image data DL′ and the right-eye image data DR′ supplied to the display device are filtered out by an image data combining circuit on a pixel-by-pixel basis and are processed to the left-eye image data DL and the right-eye image data DR, reducing the horizontal resolution by 50 percent. The image data DL and DR are alternately rearranged on a subpixel-by-subpixel basis and combined, producing the combined data D (see Japanese Patent Application No. JP-A-2000-244946).

FIGS. 10A to 10C show plan views of portions of an image of the combined data displayed on the screen W. FIG. 10A shows a combined image of the left-eye image L and the right-eye image R, FIG. 10B shows the right-eye image R as observed through the parallax barrier B, and FIG. 10C shows the left-eye image L as observed through the parallax barrier B. In each drawing, the characters “r,” “g” and “b” represent subpixels associated with color filters of red, green, and blue, respectively.

As shown in FIG. 10A, the subpixels of the right-eye image R and the subpixels of the left-eye image L are arranged into an alternating pattern of subpixels in the horizontal direction. As viewed from the vertical direction, the plurality of subpixels of the right-eye image R and the plurality of subpixels of the left-eye image L are arranged into a pattern of alternating columns. Thus, the plurality of subpixels of images R and L are arranged according to the direction of the color filters (here, in the vertical direction) into stripes. The right-eye image R and the left-eye image L shown in FIG. 8 each represent an image formed by the subpixels, which correspond to one column of the vertical direction.

In FIG. 10B, a set of three subpixels represented by the coordinates (n, k) constitute one display pixel PR for the right-eye image R. That is, the display pixel PR is composed of a group of three (red, blue, and green) subpixels. The display pixel PR is a minimum display unit for displaying a post-combined right-eye image R, and is different from the pixel displayed on the screen W. That is, the display pixel PR is different from the pixel composed of a set of three (red, green, and blue) subpixels that are arranged adjacently in the horizontal direction. On the screen W, a plurality of display pixels PR for the right eye (right-eye display pixel) are arranged in the horizontal and vertical directions. The plurality of right-eye display pixels PR form the entire right-eye image R.

In FIG. 10C, a set of three subpixels represented by the same coordinates (n, k) constitute one display pixel PR for the left-eye image L. That is, the display pixel PL is composed of the group of three subpixels of red, blue, and green. The display pixel PL is a minimum display unit for displaying a post-combined left-eye image L, and is different from the pixel displayed on the screen W. That is, the display pixel PL is different from a set of three (red, green, and blue) subpixels that are arranged adjacently in the horizontal direction. A plurality of display pixels PL for the left eye (left-eye display pixel) are arranged on the screen W in the horizontal and vertical directions. The plurality of left-eye display pixels PL form the entire left-eye image L.

However, since the display pixels PR and PL are composed of the group of three adjoining subpixels, the size of the display pixels PR and PL is double the size in the horizontal direction than required for displaying a two-dimensional image (that is, the number of display pixels used is doubled). Thus, the left-eye image L and the right-eye image R must be compressed, making it difficult to sufficiently produce a fine image. Particularly, when images are blocked and condensed using the stripe barrier method, the resulting image may be unclear and be perceived as a coarse image since the human eyes are more sensitive to the compressing of the horizontal resolution than the compressing of the vertical resolution.

### BRIEF SUMMARY OF THE INVENTION

An advantage of some aspects of the invention is that it provides a display device and an image processing method which is capable of displaying a stereoscopic image or a multi-viewpoint image with a high resolution. Another advantage of some aspects of the invention is that it provides an electronic apparatus having a display device which is capable of displaying a stereoscopic image or a multi-viewpoint image with a clear and smooth border.

One aspect of the invention is a display device which includes pixels comprised of a plurality of subpixels of different colors, a display unit capable of arranging the pixels in horizontal and vertical directions; an image data combining circuit which is capable of combining image data for a plurality of images to be displayed on the display unit with each other; and an image separation member that is capable of spatially separating the plurality of images displayed on the display unit from each other. The plurality of images are displayed as a plurality of rows, wherein the rows are organized as alternating subpixels of the images in both the horizontal and vertical directions. One advantage of the configuration is the ability to display an image without reducing the horizontal resolution, meaning that it is possible to display a clear image.

Another aspect of the invention is an image processing method wherein a plurality of images are combined and displayed on one screen. The method comprises displaying the plurality of images using a plurality of rows, wherein the plurality of rows are organized by alternating the sub-pixels of the plurality of images in both the horizontal and vertical direction. According to such a method, since the horizontal resolution is not reduced, it is possible to display a clear image.

Another aspect of the invention is an electronic apparatus including the display device described above, which is capable of displaying a stereoscopic image or a multi-viewpoint image with a clear and smooth border.

### BRIEF DESCRIPTION OF THE DRAWINGS

The invention will be described with reference to the accompanying drawings, wherein like numbers reference like elements.

FIG. 1 is a schematic diagram showing the construction of a display device in accordance with a first embodiment of the invention;

FIG. 2 is a block diagram showing the construction of the display device;

FIG. 3 is a block diagram showing the electrical construction of a display unit and a peripheral driving circuit of the display device;

FIG. 4 is a diagram for explaining an image processing method of the display device;

FIGS. 5A to 5C are plan views of an example an image that is combined using the image processing method;

FIGS. 6A to 6C are plan views of another example of an image that is combined using the image processing method;

FIG. 7 is a schematic diagram showing a cellular phone as an example of an electronic apparatus;

FIG. 8 is a schematic diagram showing a known display device;

FIGS. 9A to 9C are diagrams of an image processing method of the display device; and

FIGS. 10A to 10C are plan views of an image combined using the image processing method.

### DESCRIPTION OF EXEMPLARY EMBODIMENTS

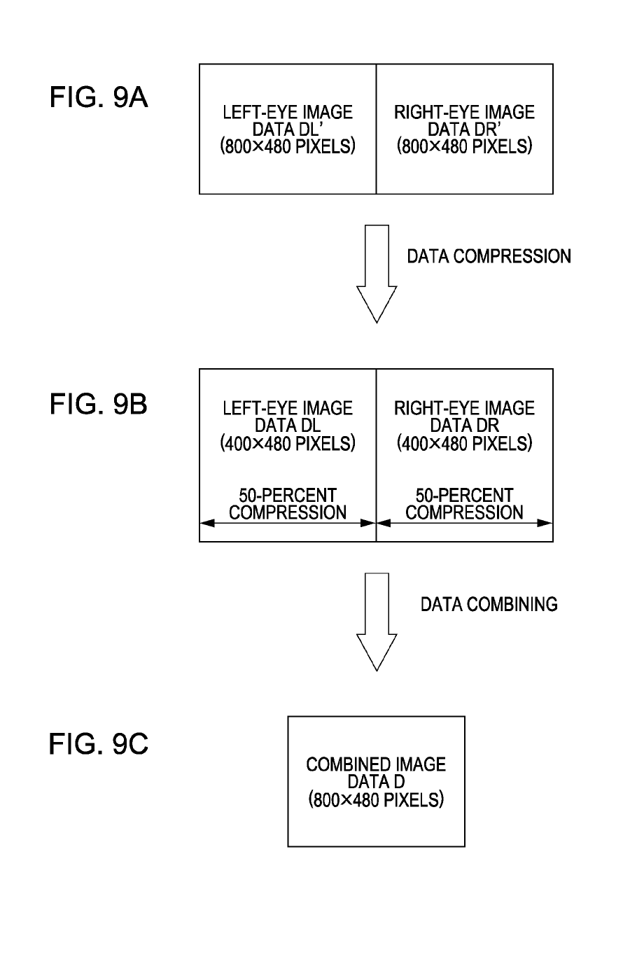

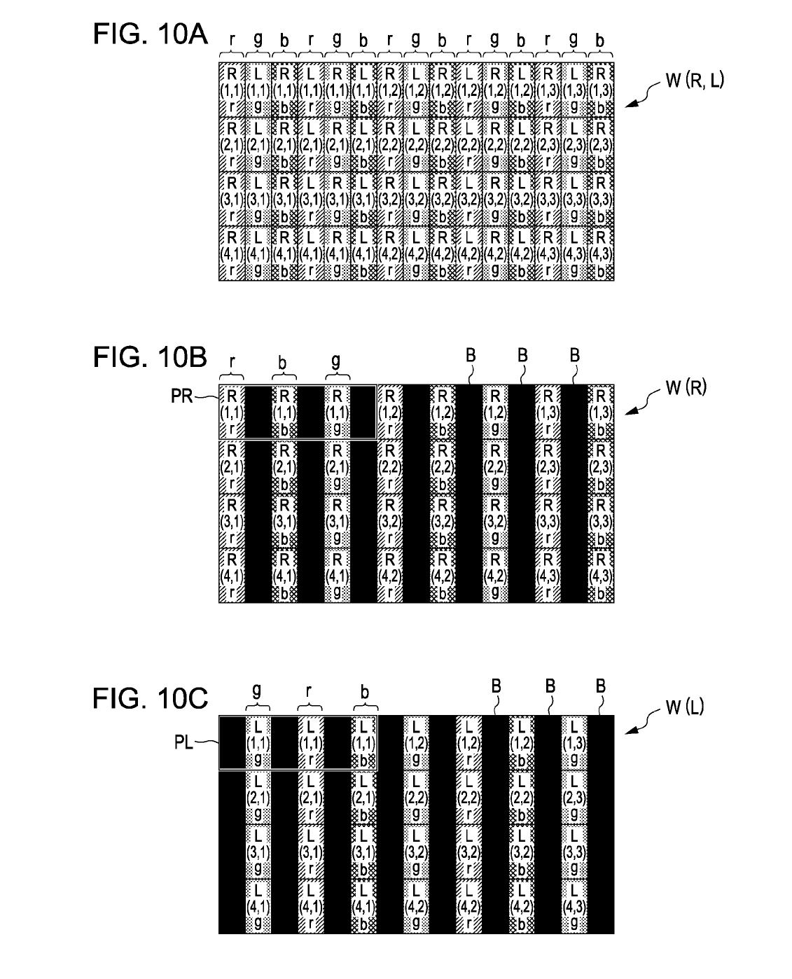

Hereinafter, embodiments of the invention will be described with reference to the accompanying drawings. In the following descriptions, the column direction of the screen (the arrangement direction of data lines) will be referred to as the “vertical direction,” and the row direction of the screen (the arrangement direction of scanning lines) will be referred to as the “horizontal direction”. The same components as those of the known display device shown in FIGS. 8 to 10 will be referenced by the same reference numerals, and the detailed descriptions thereof will be omitted.

### First Embodiment

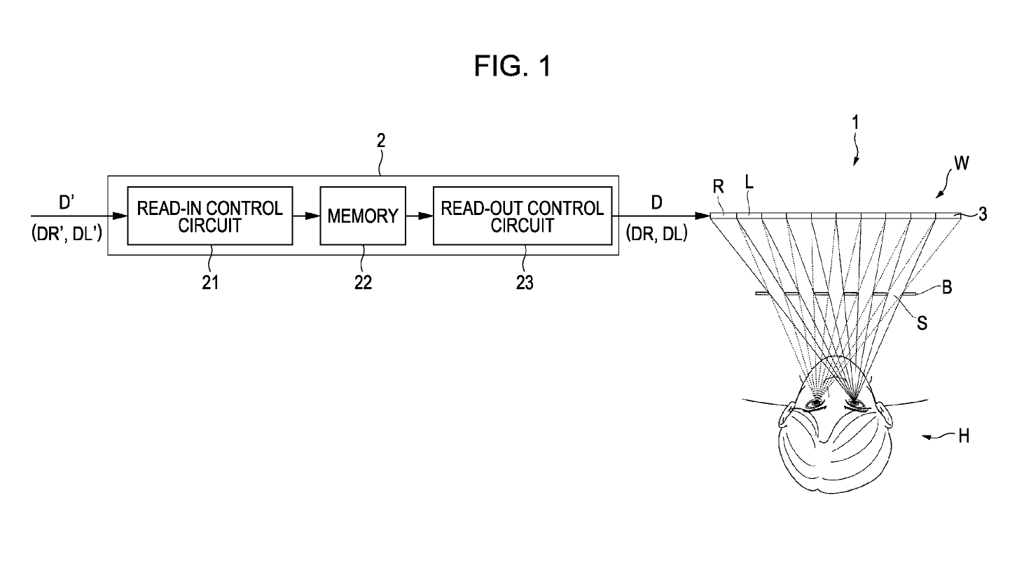

FIG. 1 is a schematic diagram showing a display device 1 of a first embodiment of the invention. The display device 1 includes an image data combining circuit 2 that combines multiple image data D′, including a plurality of image data DR′ and DL′, into image data D which corresponds to one screen. The display device 1 also includes a display panel that displays the image data D supplied from the image data combining circuit 2 on the screen W and a parallax barrier (image separation member) B that spatially separates the plurality of images R and L displayed on the screen W so as to display the images R and L to the right eye and the left eye of the observer H, respectively.

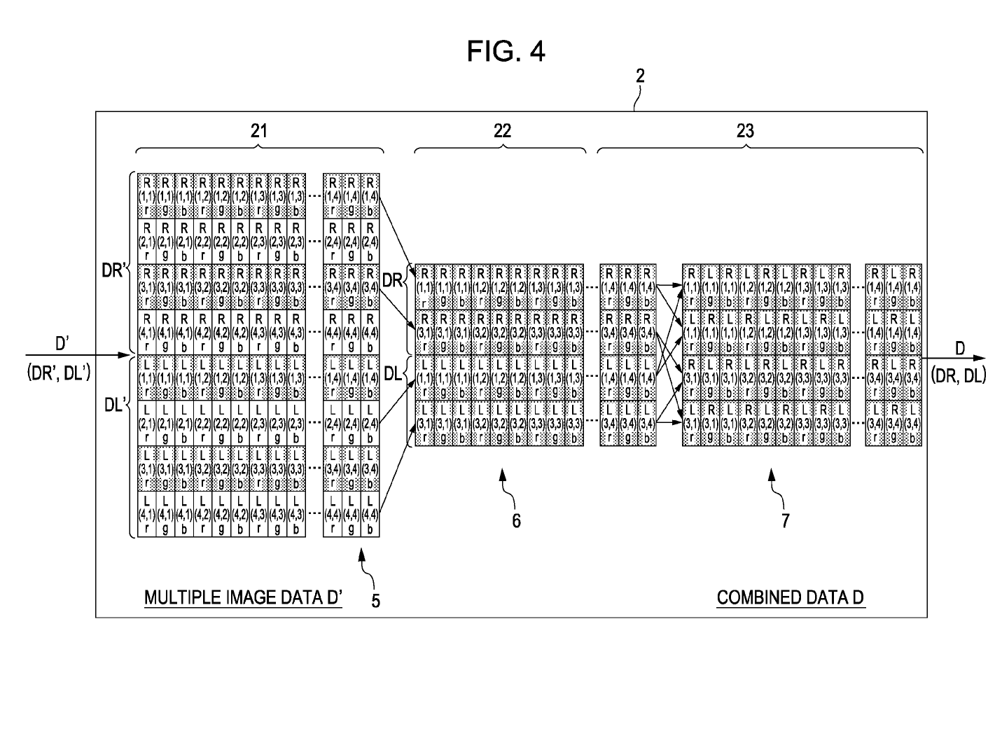

The multiple image data D′ includes the right-eye image data DR′ and the left-eye image data DL′. The right-eye image data DR′ and the left-eye image data DL′ each include image data which corresponds to one screen. As shown in FIG. 4, the right-eye image data DR′ is allocated to the upper half portion of the data area, and the left-eye image data DL′ is allocated to the lower half portion of the data area. This way, a multiple image data D′ may be produced which includes image data corresponding to a plurality of screens.

The image data combining circuit 2 includes the read-in control circuit 21 that compresses the multiple image data D′ and sequentially stores the compressed image data in the memory 22; and the read-out control circuit 23 which reads out the image data stored in the memory 22 in accordance with a predetermined rule and outputs the image data as the image data D, which corresponds to one screen. The image data combining circuit 2 filters out portions of the right-eye image data DR′ and the left-eye image data DL′ included in the multiple image data D′ using the read-in control circuit 21, and alternately rearranges the image data DR′ and DL′ using the memory 22, thereby combining new image data D.

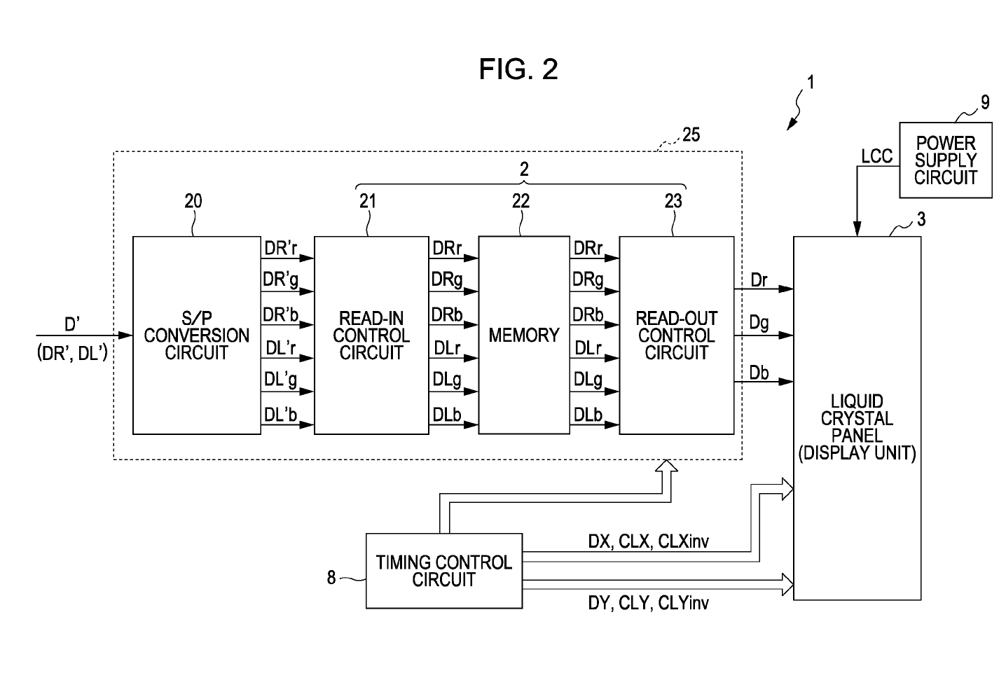

FIG. 2 is a block diagram showing the construction of the display device 1. The display device 1 includes a liquid crystal panel 3 serving as the display unit, an image data supply circuit 25, a timing control circuit 8, and a power supply circuit 9.

The timing control circuit 8 is provided with a timing signal generating unit (not shown) that generates dot clocks for scanning pixels of the liquid crystal panel 3. Based on the dot clocks generated by the timing signal generating unit, the timing control circuit 8 generates a Y clock signal CLY, an inverted Y clock signal CLYinv, an X clock signal CLX, an inverted X clock signal CLXinv, a Y start pulse DY, and an X start pulse DX, which are supplied to the image data supply circuit 25 and the liquid crystal panel 3.

The image data supply circuit 25 includes an S/P conversion circuit 20, a read-in control circuit 21, a memory 22, and a read-out control circuit 23. The S/P conversion circuit 20 divides a chain of multiple image data D′ serially supplied from an external source into image data components DR′r, DR′g and DR∝ b for the right-eye image and image data components DL′r, DL′g and DL′b and outputs the image data components as six-phase-developed image data. The read-in control circuit 21 filters out portions of six image data components DR′r, DR′g, DR′b, DL′r, DL′g and DL′b that were phase-developed by the S/P conversion circuit 20 in order to produce six new image data components DRr, DRg, DRb, DLr, DLg and DLb, which are supplied to the memory 22. The read-out control circuit 23 rearranges the image data components DRr, DRg, DRb, DLr, DLg and DLb stored in the memory 22, and outputs image data components Dr, Dg, and Db for the combined image. Image data components designated by “r,” “g” and “b” are image data components of red, green, and blue, respectively. The image data components Dr, Dg, and Db respectively are image data components of red, green, and blue for the combined image of the right-eye image and the left-eye image.

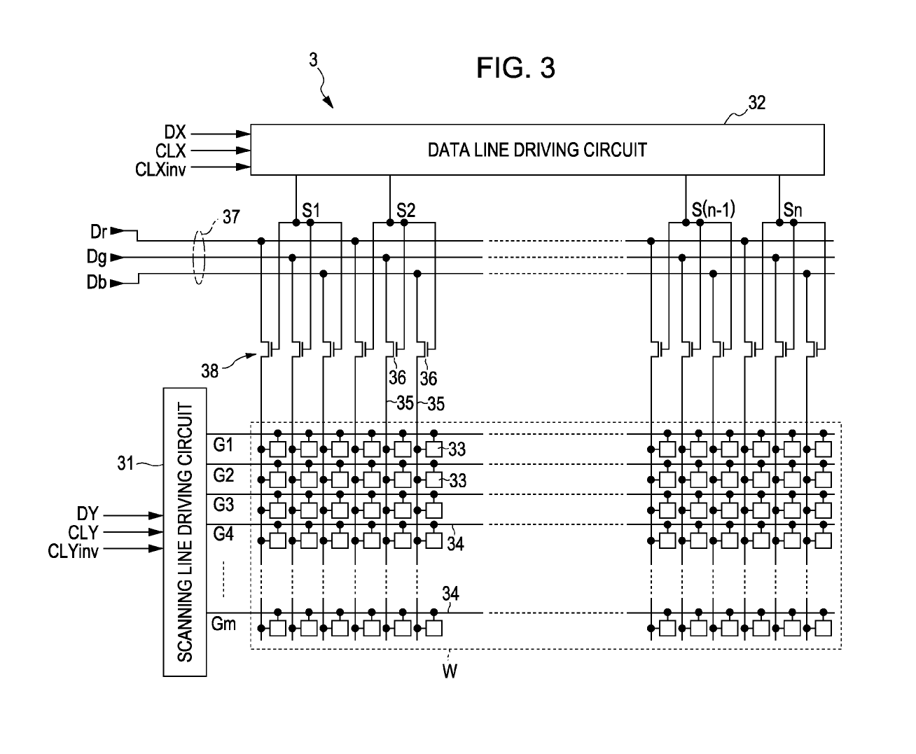

FIG. 3 is a block diagram showing the electrical construction of the liquid crystal panel 3 and a peripheral driving circuit of the display device 1. The liquid crystal panel 3 is provided with an image display area (screen) W for displaying the image data components Dr, Dg, and Db. In the image display area W, a plurality of pixel electrodes 33 are aligned in a matrix in the horizontal and vertical directions. At the borders of the pixel electrodes 33, a plurality of horizontal scanning lines 34 and a plurality of vertical data lines 35 are arranged. In addition, TFTs (not shown) which serve as pixel switching elements are arranged near the intersections of the scanning lines 34 and the data lines 35. The pixel electrodes 33 are electrically connected to the scanning lines 33 and the data lines 35 via the TFTs.

Each formation area of the pixel electrodes 33 constitutes a subpixel. Each subpixel corresponds to a color element, such as red, green, or blue. The whole image display area W is formed by arranging the subpixels in the horizontal and vertical directions. Although not shown in the drawings, a plurality of color filters are arranged as stripes on the image display area W. Each color filter has a red, green, or blue color, which corresponds to a column of subpixels arranged in the vertical direction. The color filters of red, green, and blue are alternately arranged to correspond with the alternating subpixels. One pixel (panel pixel) is comprised of three subpixels which correspond to three color filters of red, green, and blue.

In the peripheral portion of the image display area W, a peripheral driving circuit is provided, which includes a scanning line driving circuit 31, a data line driving circuit 32, and a sampling circuit 38. These circuits may be integrally formed on the substrate of the pixel electrodes 33 or may be separately provided as driving ICs.

Between the data line driving circuit 32 and the sampling circuit 38, three image signal lines 37 are provided for supplying the image data components Dr, Dg, and Db. Each of the three image signal lines 37 corresponds to any one of the three-phase-developed, red-, green- and blue-image data components Dr, Dg, and Db.

One end of each data line 35 is electrically connected to a corresponding sampling switch 36. Each sampling switch 36 is electrically connected to any one of three image signal lines 37 for supplying three-phase image data components Dr, Dg, and Db. The sampling switches 36 are arranged in the horizontal direction and constitute the sampling circuit 38.

The scanning line driving circuit 31 receives the Y clock signal CLY, the inverted Y clock signal CLYinv and the Y start pulse DY from the timing control circuit 8 shown in FIG. 2. Upon receiving the Y start pulse DY, the scanning line driving circuit 31 sequentially generates and outputs scanning signals G1, G2, . . . , Gm in synchronization with the Y clock signal CLY and the inverted Y clock signal CLYinv.

The data line driving circuit 32 receives the X clock signal CLX, the inverted X clock signal CLXinv and the X start pulse DX from the timing control circuit 8 shown in FIG. 2. Upon receiving the X start pulse DX, the data line driving circuit 32 sequentially generates and outputs sampling signals S1, S2, . . . , Sn in synchronization with the X clock signal CLX and the inverted X clock signal CLXinv.

The sampling signals are supplied to each pixel (panel pixel) in a set of three (red, green, and blue) subpixels that are arranged adjacently in the horizontal direction. The data line driving circuit 32 sequentially supplies the sampling signals S1, S2, . . . , Sn to the sampling switches 36 on a pixel-by-pixel basis. The sampling switches 36 are sequentially turned ON in accordance with the sampling signals. The image data components Dr, Dg, and Db are sequentially supplied to the data lines 35 on a pixel-by-pixel basis via the turned ON sampling switches 36.

Next, an image processing method of the image data combining circuit 2 will be described with reference to FIG. 4. First, the read-in control circuit 21 reads in the multiple image data D′. The read-in control circuit 21 filters out portions of the right-eye image data DR′ and the left-eye image data DL′ included in the multiple image data D′ and produces new right-eye image data DR and new left-eye image data DL, thereby sequentially supplying the new image data DR and DL to the memory 22.

The multiple image data D′ includes right-eye image data DR′ corresponding to one screen, which is represented as R(1, 1), R(1, 2), and left-eye image data DL′ corresponding to one screen, which is represented by L(1, 1), L(1, 2). In FIG. 4, numeral 5 represents the arrangement of the multiple image data D′ corresponding to one screen supplied from an external source; and numeral 6 represents the arrangement of the multiple image data D′ in a storage area of the memory 22. Numeral 7 represents the arrangement of the image data (combined data) D for to one screen obtained by selecting and rearranging a portion of the multiple image data D′. The combined data D includes the right-eye image data DR obtained by extracting a portion of the right-eye image data DR′ along with the left-eye image data DL obtained by extracting a portion of the left-eye image data DL′. These image data DR and DL are rearranged on the subpixel level and are output as the image data components Dr, Dg, and Db of the subpixels of red, green, and blue (see FIG. 2).

In the arrangement diagrams 5 and 7, each rectangular area represents image data of a subpixel. The characters on the upper two lines in each rectangular area represent the type (right-eye or left-eye image) of the image data along with the coordinates on the screen W of the pixel which includes the subpixel. For example, if the upper portion of the rectangular area of the image data is indicated by “R(n, k)” (wherein, n and k are integers), the image data is the right-eye image data of a pixel arranged at the n-th row and k-th column on the screen W. The character on the bottom line in each rectangular area represents the color information of the subpixel. The characters “r,” “g,” and “b” represent color information of red, green, and blue, respectively. For example, if the bottom line in the rectangular area of the image data is indicated by “m” (wherein, m is r, g or b), the image data is the image data of a subpixel corresponding to a color filter of m color. Hereinafter, the image data of the subpixel will be simply denoted as “R(n, k)m” (wherein, n and k are integers; and m is r, g or b).

First, in the read-in control circuit 21 stores image data in the memory 22, which corresponds to the right-eye image data DR′, including image data which corresponds to coordinates (1, 1), etc., and filter color. Here, the image data R(1, 1)r, R(1, 1)g, R(1, 1)b, . . . , R(1, 4)r, R(1, 4)g, and R(1, 4)b are stored in the memory 22. In this configuration, the image data R(2, 1)r, R(2, 1)g, R(2, 1)b, . . . , R(2, 4)r, R(2, 4)g, and R(2, 4)b are filtered out and thus are not stored in the memory 22, while the image data R(3, 1)r, R(3, 1)g, R(3, 1)b, . . . , R(3, 4)r, R(3, 4)g, and R(3, 4)b are stored in the memory 22.

In this configuration, the image data corresponding to odd-numbered rows are stored in the memory 22, and the image data in even-numbered rows are filtered out without being stored in the memory 22. As a result, new right-eye image data DR having half the amount of information than the right-eye image data DR′ are stored in the memory 22. The new right-eye image data DR is obtained by storing a portion of the original right-eye image data DR′ while filtering out the remaining portion of the original right-eye image data DR′. Thus, the information amount of the image data DR is reduced by 50 percent.

After completing the image processing operation for the right-eye image data DR′, the image processing operation for the left-eye image data DL′ is performed. Using a process similar to the one described above, the read-in control circuit 21, stores image data for the left-eye image data DL′, corresponding to the row and arranged at coordinates (1, 1). Thus, the image data L(1, 1)r, L(1, 1)g, L(1, 1)b, . . . , L(1, 4)r, L(1, 4)g, and L(1, 4)b is stored in the memory 22. Then the image data of the next row arranged at coordinates (2, 1), are filtered out. Thus, the image data L(2, 1)r, L(2, 1)g, L(2, 1)b, . . . , L(2, 4)r, L(2, 4)g, and L(2, 4)b are not stored in the memory 22, while the image data of the next row at coordinates (3, 1), i.e., the image data L(3, 1)r, L(3, 1)g, L(3, 1)b, . . . , L(3, 4)r, L(3, 4)g, and L(3, 4)b are stored in the memory 22.

In this way, the image data corresponding to odd-numbered rows are stored in the memory 22, and the image data in even-numbered rows are filtered out without being stored in the memory 22. As a result, new left-eye image data DL with half the amount of information the original left-eye image data DL′ is stored in the memory 22. The new left-eye image data DL are obtained by selecting a portion of the original left-eye image data DL′ in a predetermined row while filtering out the remaining portion of the original left-eye image data DL′. Thus, the information amount of the image data DL is reduced by 50 percent.

After the image processing operation, the read-out control circuit 23 reads out the right-eye image data DR and the left-eye image data DL from the memory 22 according to a predetermined rule. The red, green, and blue subpixels included in the pixel at coordinates (1, 1) are supplied with the image data R(1, 1)r, L(1, 1)g, and R(1, 1)b, respectively. The red, green, and blue subpixels included in the pixel at coordinates (1, 2) are supplied with the image data L(1, 2)r, R(1, 2)g, and L(1, 2)b, respectively. The red, green, and blue subpixels included in the pixel at coordinates (1, 3) are supplied with the image data R(1, 3)r, L(1, 3)g, and R(1, 3)b, respectively. The red, green, and blue subpixels included in the pixel at coordinates (1, 4) are supplied with the image data L(1, 4)r, R(1, 4)g, and L(1, 4)b, respectively.

Similarly, the red, green, and blue subpixels included in the pixel at coordinates (2, 1) are supplied with the image data L(2, 1)r, R(2, 1)g, and L(2, 1)b, respectively, and the red, green, and blue subpixels included in the pixel at coordinates (2, 2) are supplied with the image data R(2, 2)r, L(2, 2)g, and R(2, 2)b, respectively. The red, green, and blue subpixels included in the pixel at coordinates (2, 3) are supplied with the image data L(2, 3)r, R(2, 3)g, and L(2, 3)b, respectively, and the red, green, and blue subpixels included in the pixel at coordinates (2, 4) are supplied with the image data R(2, 4)r, L(2, 4)g, and R(2, 4)b, respectively.

In this configuration, the right-eye image data corresponding to the first and second rows, (the image data R(1, 1)r, R(1, 1)g, R(1, 1)b, . . . , R(2, 4)r, R(2, 4)g, and R(2, 4)b), and the left-eye image data corresponding to the first and second rows, (the image data L(1, 1)r, L(1, 1)g, L(1, 1)b, . . . , L(2, 4)r, L(2, 4)g, L(2, 4)b), are alternately stored on the subpixel level in both the horizontal and vertical directions. The right-eye image data and the left-eye image data corresponding to the first row are combined into image data which corresponds to two rows (the first and second rows) on the screen W. Using the same technique, the image data corresponding to the third and fourth rows on the screen W is created.

In this way, the right-eye image data corresponding to the odd-numbered rows (the p-th rows) and the left-eye image data corresponding to the odd-numbered rows (the p-th rows) are alternately stored at the subpixel level in both the horizontal and vertical direction. Similarly, the right-eye image data corresponding to the p-th row and the left-eye image data corresponding to the p-th row are combined into image data corresponding to two rows (the p-th and (p+1)-th rows) on the screen W. As a result, a new image data (combined data) D is produced by combining the right-eye image data DR and the left-eye image data DL.

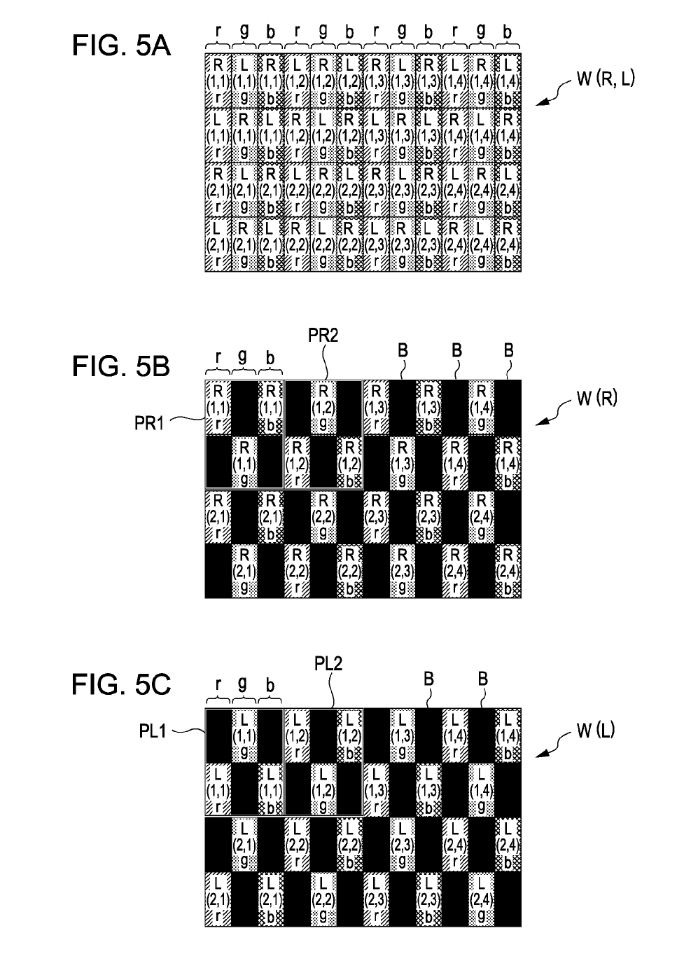

FIGS. 5A and 5C show plan views of a part of an image of the combined data D displayed on the screen W. In the drawing, FIG. 5A shows a combined image of the left-eye image L and the right-eye image R. FIG. 5B shows the right-eye image R as observed through the parallax barrier B, and FIG. 5C shows the left-eye image L as observed through the parallax barrier B. In the drawing, the characters “r,” “g” and “b” respectively represent subpixels associated with the color filters of red, green, and blue.

As shown in FIG. 5A, the subpixels of the right-eye image R and the subpixels of the left-eye image L are arranged in an alternating pattern in both the horizontal and vertical direction. As viewed from the horizontal direction, the first row of the right-eye image R and first row of the left-eye image L are displayed over two rows; and subpixels for displaying the right-eye image R and subpixels for displaying the left-eye image L are arranged in zigzagged pattern.

In FIG. 5B, a set of three subpixels represented by the same coordinates (n, k) constitutes one display pixel PR1 or PR2 for the right-eye image R. That is, the display pixel PR1 represented by coordinates (1, 1) is composed of the red and blue subpixels in the first row of the screen W and the green subpixel in the second row of the screen W. The display pixel PR2 represented by coordinates (1, 2) is composed of the green subpixel in the first row of the screen W and the red and blue subpixels in the second row of the screen W. Each display pixel PR1 and PR2 is a minimum display unit for displaying a post-combined right-eye image R, and is different from the pixel (panel pixel) displayed on the screen W. That is, the display pixels PR1 and PR2 are different from the pixel composed of a set of three (red, green, and blue) subpixels which are arranged adjacently in the horizontal direction. On the screen W, a plurality of display pixels PR1 and PR2 for the right eye (right-eye display pixel) are arranged in the horizontal and vertical directions. The plurality of right-eye display pixels PR1 and PR2 form the entire right-eye image R.

In FIG. 5C, a set of three subpixels represented by the same coordinates (n, k) constitute one display pixel PL1 or PL2 for the left-eye image L. That is, the display pixel PL1 represented by coordinates (1, 1) is composed of the green subpixel in the first row of the screen W and the red and blue subpixels in the second row of the screen W. The display pixel PL2 represented by coordinates (1, 2) is composed of the red and blue subpixels in the first row of the screen W and the green subpixel in the second row of the screen W. Each display pixel PL1 and PL2 is a minimum display unit for displaying a post-combined left-eye image L, which is different from the pixel (panel pixel) of the screen W. That is, each display pixel PL1 and PL2 is different from the pixel composed of a set of three (red, green, and blue) subpixels that are arranged adjacently in the horizontal direction. On the screen W, a plurality of display pixels PL1 and PL2 for the left eye (left-eye display pixel) are arranged in the horizontal and vertical directions. The plurality of left-eye display pixels PL1 and PL2 form the entire left-eye image L.

The size in the horizontal direction of the individual display pixels PR1 and PR2 is equal to that of the pixels (panel pixels) required for displaying the two-dimensional image. Thus, the resolution is not reduced, even when displaying a fine image. Accordingly, the right-eye image R formed by the display pixels PR1 and PR2 has a high horizontal resolution and a smooth border.

The above statements can be similarly applied to the left-eye image L shown in FIG. 5C. The size in the horizontal direction of the individual display pixels PL1 and PL2 is equal to that of the pixels (panel pixels) required for displaying the two-dimensional image. Thus, the resolution is not reduced when displaying a fine image. Accordingly, the left-eye image L formed by the display pixels PL1 and PL2 has a high horizontal resolution and a smooth border.

As described above, according to the display device 1 of the present embodiment, since the size in the horizontal direction of the display pixels PR1, PR2, PL1, and PL2 for displaying a combined image is equal to that of the pixels (panel pixels) required for displaying the two-dimensional image, it is possible to display a clear image with a high resolution. In this case, although a resulting image may become coarse in the vertical direction, it can be negated by additionally inputting image data having a density that is doubled in the vertical direction, as the multiple image data D′.

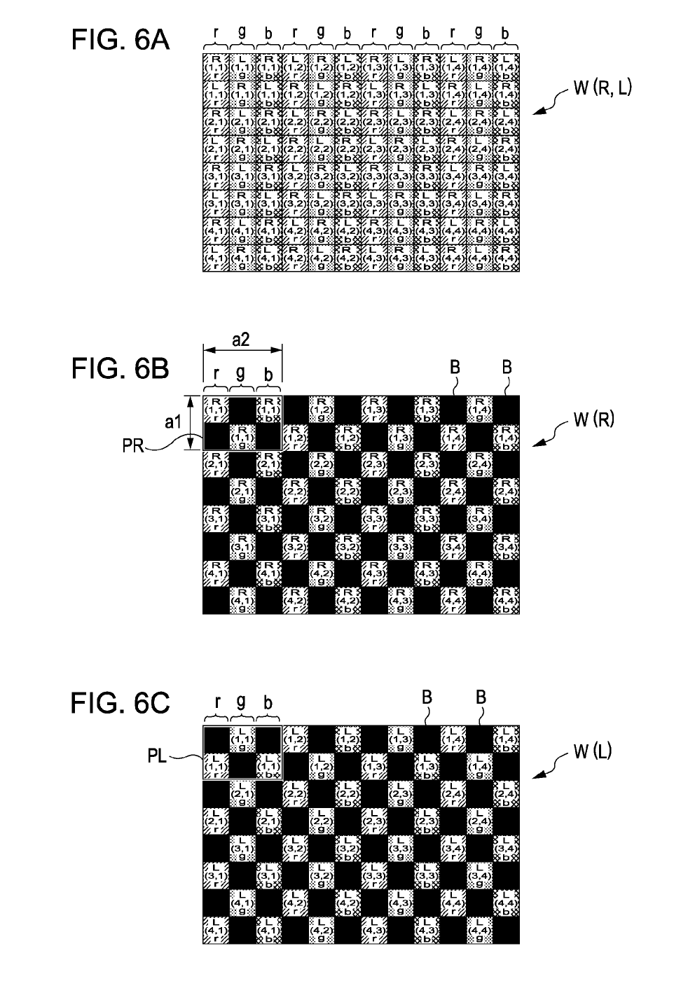

FIGS. 6A to 6C show an example wherein image data having a normal density in the vertical direction is supplied as the multiple image data D′ and is displayed on the display panel 3 having a pixel density which is doubled in the vertical direction. The width of one subpixel in the vertical direction on the display panel 3 (screen W) is half the size than shown in FIGS. 5A to 5C. Since the aspect ratio of the whole screen is the same as that shown in FIGS. 5A to 5C, the density of subpixels in the vertical direction on the display panel 3 shown in FIGS. 6A to 6C is twice the density of the display panel shown in FIGS. 5A to 5C. For this reason, the aspect ratio (a1:a2) in the horizontal and vertical directions of one display pixel PR and PL arranged over two rows is 1:1, meaning that the resulting image is not deformed in the vertical direction. Since a high resolution can be realized in both the horizontal and vertical direction, it is possible to display a clearer image.

Another embodiment of the invention includes a stereoscopic display device for displaying a stereoscopic image, however, the invention may be applied in an number of multi-viewpoint display devices for presenting a multi-viewpoint image to a plurality of observers. In the case of the stereoscopic display device, the right-eye image data DR′ and the left-eye image data DL′ are prepared as the image data for display, and the right-eye image R and the left-eye image L are spatially separated using the image separating unit (parallax barrier, for example). In a multi-viewpoint display device the multi-viewpoint image data is prepared as the image data for display, and images of different viewpoints are spatially separated using the image separating unit (parallax barrier, for example). For example, in the case of a display device for an on-vehicle navigation system, an image of a first viewpoint (driver's seat side) and an image of a second viewpoint (passenger's seat side) may be prepared as a navigation image and a television image, respectively, and presented to the corresponding observers (driver and passenger) using the image separating unit. In the case of the stereoscopic display device, the arrangement between the panel pixel and the apertures of the parallax barrier is based on position of the right and left eyes, while in a multi-viewpoint display device, the arrangement relationship between the panel pixel and the apertures of the parallax barrier is based on the position of the observers.

In the present embodiment, a liquid crystal panel is used as the display unit 3. Instead of the liquid crystal panel, other display panels may be used as the display unit. For example, a non-emission-type panel such as a liquid crystal panel or an electrophoresis panel and a self-emission-type panel such as an electroluminescence (EL) panel may be used as a display panel. Moreover, image separating units other than the parallax barrier B may be used, such as lenticular lenses.

### Electronic Apparatus

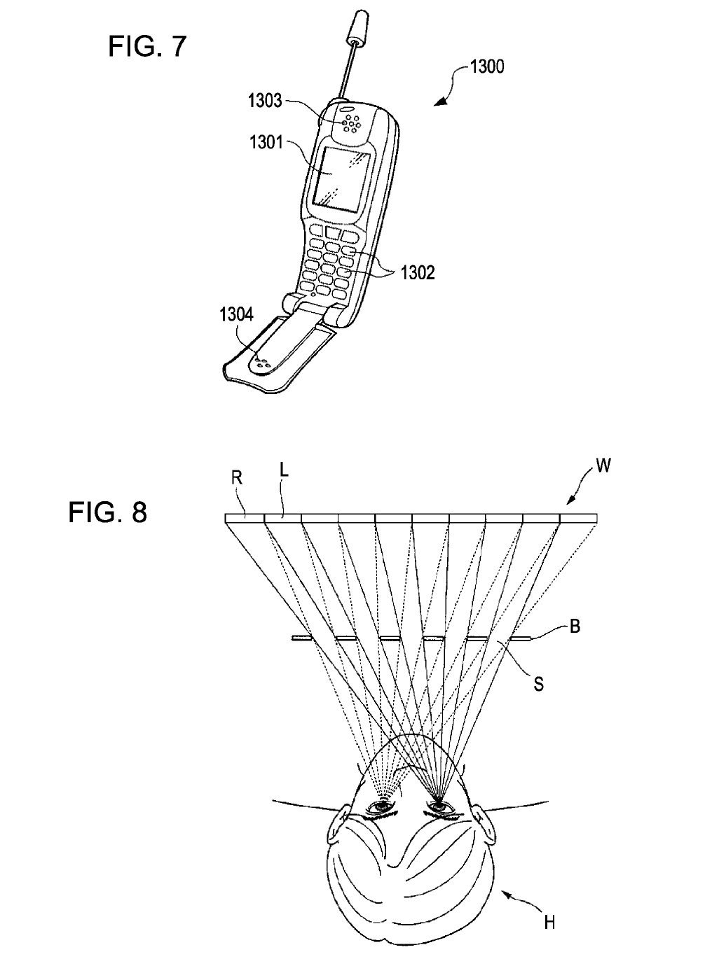

FIG. 7 is a perspective view showing an example of an electronic apparatus of the invention. In this case, the electronic apparatus is a cellular phone 1300 which includes a plurality of operation buttons 1302, an earpiece 1303, a mouthpiece 1304, and a display unit 1301 wherein the display device of the invention may be applied. Other electronic apparatuses wherein the display device of the above embodiments may be applied include electronic books, personal computers, digital still cameras, liquid crystal TVs, view-finder-types (or monitor-direct-view-type) of video tape recorders, car navigation devices, pagers, electronic organizers, calculators, word processors, workstations, video phones, POS terminals, and various apparatuses equipped with touch panels. In each configuration, it is possible display an image with a clear and smooth border.

Although the exemplary embodiments of the invention have been described with reference to the accompanying drawings, it should be understood that the invention is not limited to such embodiments. Various shapes or combinations of respective constituent elements illustrated in the above-described embodiments are merely examples, and various changes may be made depending on design requirements or the like without departing from the spirit or scope of the invention.

What is claimed is:

1. A display device, comprising:
a plurality of images comprised of rows of pixels including a plurality of subpixels of different colors;
a display unit which is capable of arranging the pixels in horizontal and vertical directions;
an image data combining circuit which is capable of combining image data for a plurality of images to be displayed on the display unit with each other; and
an image separation member which is capable of spatially separating the display the plurality of images displayed on the display unit from each other;
wherein the plurality of image data is displayed as rows of display pixels of the plurality of images, and wherein the plurality of images are displayed as display pixels by displaying alternating subpixels of the images in the horizontal and vertical direction.

2. The display device according to claim 1, wherein the aspect ratio of a display pixel is 1:1.

3. The display device according to claim 1, wherein the image data combining circuit is capable of separating the image data for the plurality of images into a plurality of rows and filtering the image data on a row-by-row basis in order to compress the image data for the plurality of images.

4. The display device according to claim 3, wherein the image data combining circuit comprises:
a read-in control circuit that is capable of selectively reading into a memory the image data for the plurality of images supplied from an external source; and
a read-out control circuit that reads out the image data read into the memory and outputs the image data for the plurality of images to the display unit on a row-by-row basis.

5. The display device according to claim 1, wherein the plurality of images include an image for the left eye and an image for the right eye.

6. The display device according to claim 1, wherein the plurality of images include a first-viewpoint image observed from a first viewpoint and a second-viewpoint image observed from a second viewpoint.

7. An image processing method in which a plurality of images are combined and displayed on one screen, the method comprising:
displaying the plurality of images as a plurality of rows of display pixels comprised of subpixels of different colors; and
displaying the plurality of images by alternating subpixels of the images in the horizontal and vertical direction.

8. An electronic apparatus comprising the display device according to claim 1.

9. A method of combining a plurality of images in a display comprised of a single screen, the method comprising:
receiving the plurality of images as image data comprised of rows of pixels, the pixels including subpixels corresponding to different colors;
combining image data for a plurality of images by filtering out a predetermined number of rows of the image data; and
displaying the plurality of images in a single screen by alternating subpixels of the images in the horizontal and vertical direction.

10. The method according to claim 9, wherein the plurality of images include an image for the left eye and an image for the right eye.

11. The method according to claim 9, wherein the plurality of images include a first-viewpoint image observed from a first viewpoint and a second-viewpoint image observed from a second viewpoint.
